(19) United States
(12) Patent Application Publication
(10) Pub. No.: US 2024/0388049 A1
(43) Pub. Date: Nov. 21, 2024

(54) WIRE END PROCESSING APPARATUS

(71) Applicant: Shinmaywa Industries, Ltd., Takarazuka-shi, Hyogo (JP)

(72) Inventors: Naoki FUJISAWA, Takarazuka-shi (JP); Yoshiki TAKAHASHI, Takarazuka-shi (JP)

(21) Appl. No.: 18/284,184

(22) PCT Filed: Mar. 17, 2022
(86) PCT No.: PCT/JP2022/012400

§ 371 Date: Jul. 12, 2024

(30) Foreign Application Priority Data
Mar. 31, 2021 (JP) 2021-060198

(51) Int. Cl. H01R 43/052

(52) U.S. Cl. CPC H01R 43/052

(57) ABSTRACT

A wire end processing apparatus 10 includes a crimping device 20 crimping a terminal 5 onto an end portion of an electric wire 2; a plurality of gripping members 40A through 40J each capable of gripping one electric wire 2; and a moving device 60, 70 capable of moving the plurality of gripping members 40A through 40J toward the crimping device 20 independently from each other, the moving device 60, 70 mounting the electric wire 2 gripped by the moved gripping member 40A through 40J on the crimping device 20.

### TECHNICAL FIELD

The present invention relates to a wire end processing apparatus.

### BACKGROUND ART

Wire end processing apparatuses automatically crimping a terminal onto an end portion of an electric wire deprived of a cover are conventionally known. In a conventional typical wire end processing apparatus, electric wires are sequentially inserted into an applicator of a crimping device from a position to the side of the applicator by a transportation device that transports the electric wires in a transverse direction. However, in the case where, for example, it is attempted to crimp terminals onto a plurality of core wires of a multi-core cable, a core wire that is not a target of the crimping may contact the applicator or the like and thus cause a problem. In order to solve this problem and also shorten the time required for crimping, a crimping method for crimping terminals onto a plurality of electric wires at the same time has been proposed. For example, Patent Literature 1 discloses a method for crimping terminals onto core wires of a multi-core cable in a batch manner by use of a batch crimper including a plurality of terminal pressing surfaces located parallel to each other and a batch anvil including a plurality of terminal receiving surfaces located parallel to each other.

### CITATION LIST

### Patent Literature

Patent Literature 1: Japanese Laid-Open Patent Publication No. 2010-3429

### SUMMARY OF INVENTION

### Technical Problem

With the method disclosed in Patent Literature 1, a core wire that is included in a multi-core cable but is not a target of the crimping is prevented from contacting a wire end processing apparatus, and the time required for the crimping is expected to be shortened. However, according to the method disclosed in Patent Literature 1, a plurality of terminals are crimped at the same time. Therefore, a pass/fail determination work of measuring the crimp force and determining whether the crimping work is successful or unsuccessful cannot be performed. The pass/fail determination performed by measuring the crimp force is a very important process for managing the quality of the crimping, and cannot be performed unless the crimping is performed onto one electric wire at a time. In the case where the batch crimping of a plurality of terminals onto a plurality of electric wires is performed, it is impossible to make a pass/fail determination on each of the electric wires because the crimp force onto each of the electric wires is not measured. Therefore, it is preferred that the terminal crimping is performed onto one electric wire at a time. However, in the case where a method of performing the crimping onto one electric wire of a multi-core cable at a time is used, the above-described problem may occur.

In order to solve the above-described problem, it is conceivable that one of a plurality of electric wires of a multi-core cable is gripped by an electric wire gripping device and the crimping is performed onto the gripped electric wire. In the case where this work is continued while the electric wire to be gripped is switched, the crimping is performed onto the plurality of electric wires sequentially one by one. With this method, the crimping is performed onto one electric wire at a time, while the electric wire that is not a target of the crimping is prevented from contacting the wire end processing apparatus. However, this method requires a time for switching the electric wire, and thus extends the time for the process.

The present invention, made in light of such a point, has an object of providing a wire end processing apparatus performing crimping onto a plurality of electric wires one by one and shortening the time for the crimping.

### Solution to Problem

A wire end processing apparatus according to the present invention includes a crimping device crimping a terminal onto an end portion of an electric wire; a plurality of gripping members each capable of gripping one electric wire; and a moving device capable of moving the plurality of gripping members toward the crimping device independently from each other, the moving device mounting the electric wire gripped by the moved gripping member on the crimping device.

According to the above-described wire end processing apparatus, the plurality of electric wires are gripped at the same time by the plurality of gripping members each capable of gripping one electric wire. As a result, a situation is prevented where an electric wire that is not gripped contacts the wire end processing apparatus, and the time for switching the electric wire to be gripped becomes unnecessary. In addition, the moving device is capable of moving the plurality of gripping members toward the crimping device independently from each other. Therefore, only the electric wire gripped by the moved gripping member is mounted on the crimping device. Thus, the plurality of electric wires are subjected to the crimping sequentially one by one. As a result, the crimping is performed onto the plurality of electric wires one by one, and also the time required for the crimping is shortened.

According to a preferred embodiment of the wire end processing apparatus of the present invention, the wire end processing apparatus further includes a base member supporting the plurality of gripping members such that the plurality of gripping members are aligned in a predetermined alignment direction and are each movable in a moving direction crossing the alignment direction, and a controller controlling the moving device to mount the electric wire on the crimping device. The moving device includes a first moving device moving the plurality of gripping members supported by the base member in the moving direction independently from each other, and a second moving device moving the base member in the alignment direction. The crimping device is provided on one side in the moving direction with respect to the base member. The controller controls the first moving device and the second moving device to sequentially move the plurality of gripping members to one-side end positions thereof in the moving direction and also to opposing positions thereof opposing the crimping device.

According to the above-described wire end processing apparatus, the moving device moving the plurality of gripping members toward the crimping device independently from each other is realized with a simple configuration by a combination of the second moving device causing the gripping member, gripping the electric wire as a target of the crimping, to oppose the crimping device and the first moving device causing the gripping member, gripping the electric wire as the target of the crimping, to approach the crimping device.

According to a preferred embodiment of the above-described wire end processing apparatus, the first moving device includes an engagement member provided at a predetermined engagement position in the alignment direction, and an actuator moving the engagement member in the moving direction. The gripping members are each put into engagement with the engagement member when being located at the engagement position. When moving each of the gripping members in the moving direction, the controller drives the actuator after controlling the second moving device to locate the each of the gripping members at the engagement position.

According to the above-described wire end processing apparatus, the plurality of gripping members are moved in the moving direction independently from each other with one actuator, with no need to provide an actuator for each of the gripping members.

According to a preferred embodiment of the above-described wire end processing apparatus, a one-side end position and an other-side end position of a movable range of the engagement member are away from each other by a first distance in the moving direction. The gripping members each include an engagement groove running through the gripping member in the alignment direction up to both of two side surfaces thereof such that the engagement member passes therethrough in the alignment direction, the engagement groove being engageable with the engagement member, and a clearance groove provided to be away from the engagement groove by the first distance in the moving direction toward the one-side end of the gripping member, the clearance groove running through the gripping member in the alignment direction up to both of the two side surfaces thereof such that the engagement member passes therethrough in the alignment direction.

According to the above-described wire end processing apparatus, in a state where each of the gripping members is at the one-side end position or the other-side end position thereof of a movable range thereof, a route for the engagement member is formed by the gripping member located at the other-side end position thereof. In addition, a route for the engagement member is formed of the clearance groove of the gripping member located at the other-side end position thereof and the engagement groove of the gripping member located at the one-side end position thereof. Therefore, the base member is moved in the alignment direction with no interference with the engagement member even where all the gripping members are retracted or even where some of the gripping members are moved forward toward the crimping device.

According to a preferred embodiment of the wire end processing apparatus, the crimping device includes a crimper and an anvil facing each other in a crimping direction perpendicular to the alignment direction and the moving direction. The controller moves the engagement member to the one-side end position thereof and then moves each of the gripping members to the opposing position thereof to insert the electric wire between the crimper and the anvil. After inserting the electric wire between the crimper and the anvil, the controller causes the crimper and the anvil to approach each other to crimp the terminal onto the electric wire. After crimping the terminal, the controller moves the each of the gripping members to the engagement position in the alignment direction. After moving the each of the gripping members to the engagement position, the controller moves the engagement member to the other-side end position thereof.

According to the above-described wire end processing apparatus, the electric wire is inserted between the crimper and the anvil from a position to the side of the crimping device. This decreases the risk of the electric wire colliding against the crimping device. The risk of the electric wire colliding against the crimping device is lower in the case where the electric wire is inserted into the crimping device from a position to the side of the crimping device than in the case where the electric wire is inserted into the crimping device from a position facing the crimping device. In order to perform the crimping in this manner, it is needed to move the gripping member to the one-side end position thereof in the moving direction before moving the gripping member to the opposing position thereof. Such a movement is made possible by the clearance groove formed in each of the gripping members.

According to a preferred embodiment of the wire end processing apparatus of the present invention, the wire end processing apparatus further includes a first holding mechanism holding the plurality of gripping members at other-side end positions thereof in the moving direction respectively.

According to the above-described wire end processing apparatus, a situation is prevented where the gripping member gripping the electric wire that is not a target of the crimping moves from the other-side end position thereof while the base member is moved in the alignment direction by the second moving device.

According to a preferred embodiment of the wire end processing apparatus of the present invention, the wire end processing apparatus further includes a second holding mechanism holding the plurality of gripping members at the one-side end positions thereof in the moving direction respectively.

According to the above-described wire end processing apparatus, a situation is prevented where the gripping member moved to the one-side end position thereof and gripping the electric wire as a target of the crimping is moved from the one-side end position thereof while the crimping is performed or while the base member is moved.

According to a preferred embodiment of the wire end processing apparatus of the present invention, the gripping members each include a sandwiching portion replaceable in accordance with the type of the electric wire, the sandwiching portion sandwiching the electric wire.

The above-described wire end processing apparatus of the present invention performs the crimping for any of various types of electric wires.

### Advantageous Effects of Invention

A wire end processing apparatus according to the present invention performs crimping onto a plurality of electric wires one by one, and shortens the time for the crimping.

### BRIEF DESCRIPTION OF DRAWINGS

FIG. 1 is a perspective view of a wire end processing apparatus according to an embodiment.

FIG. 2 is a plan view of the wire end processing apparatus in a state of gripping a multi-core cable.

FIG. 3 is a right side view of the wire end processing apparatus.

FIG. 4 is a perspective view of an electric wire insertion device in a state where a shuttle and a main portion of a YZ-axis moving unit are away from each other.

FIG. 5 is a bottom perspective view of the shuttle.

FIG. 6 is a bottom perspective view of the shuttle in a state where a rightmost clamp is located at a front-side end position thereof.

FIG. 7 is a block diagram of the wire end processing apparatus.

FIG. 8 is a perspective view of the electric wire insertion device in a state where the rightmost clamp is located at the front-side end position thereof.

FIG. 9 is a perspective view of the electric wire insertion device in a state where the shuttle is at an opposing position thereof.

FIG. 10 is a vertical cross-sectional view of a clamp and a holding mechanism according to a modification.

### DESCRIPTION OF EMBODIMENTS

### [Configuration of the Device]

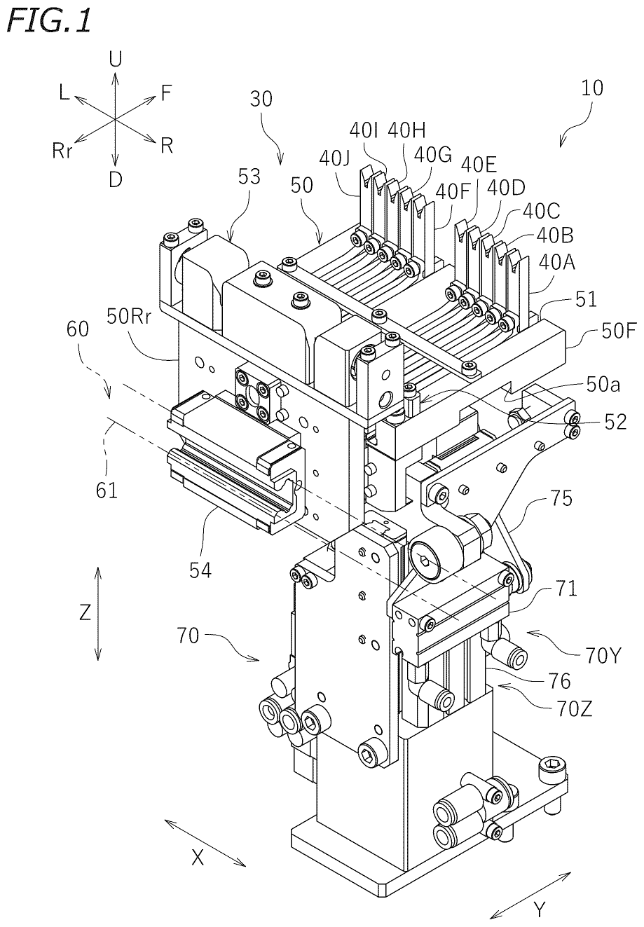

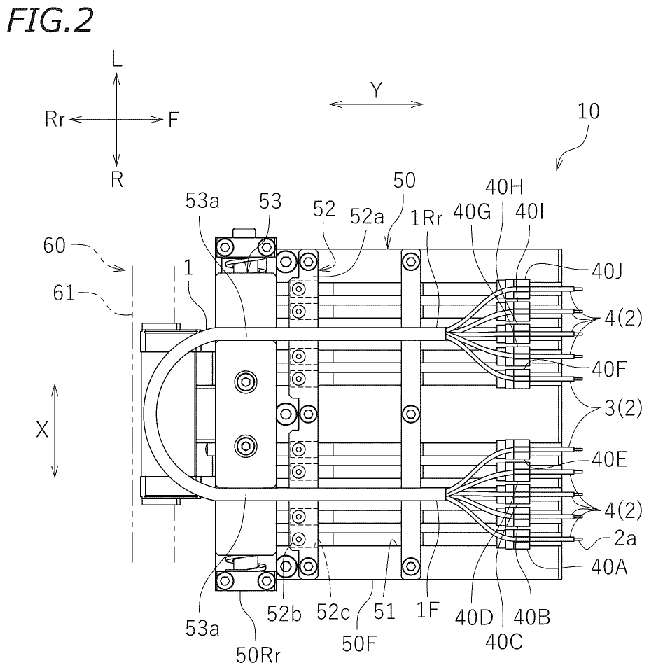

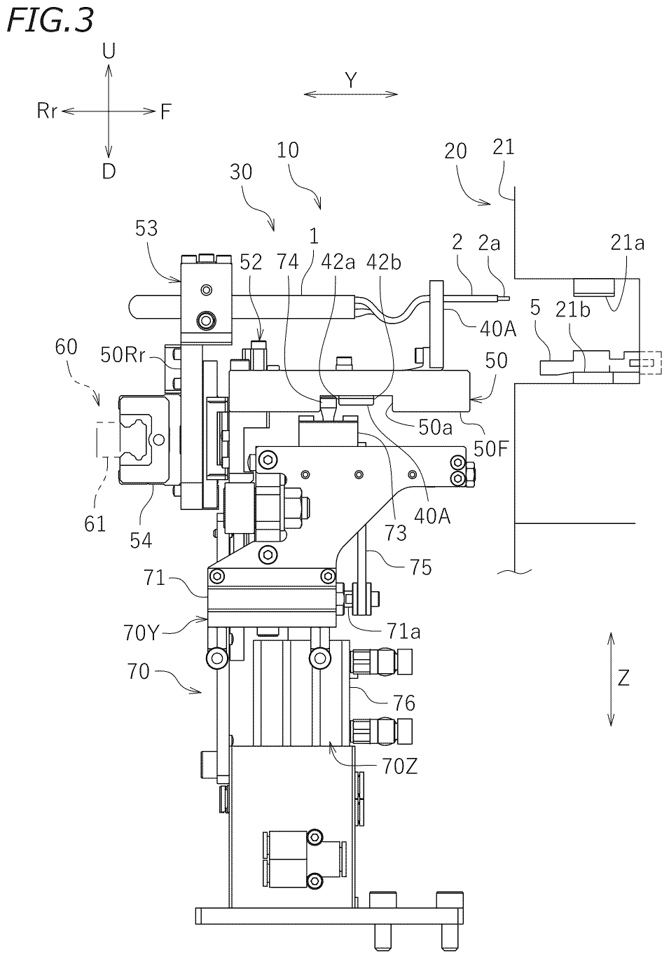

Hereinafter, an embodiment of the present invention will be described with reference to the drawings. FIG. 1 is a perspective view of a wire end processing apparatus 10 according to an embodiment. The wire end processing apparatus 10 crimps a terminal onto each of ends of a plurality of electric wires. FIG. 2 is a plan view of the wire end processing apparatus 10 in a state of gripping a multi-core cable 1. FIG. 3 is a side view of the wire end processing apparatus 10. As shown in FIG. 2, the wire end processing apparatus 10 according to this embodiment performs wire end processing mainly on the multi-core cable 1 including a drain wiring 3 and a plurality of core wirings 4. Hereinafter, the drain wiring 3 and the core wirings 4 will also be collectively referred to as “core wires 2” unless it is specifically necessary to distinguish these wirings. The wire end processing apparatus 10 may perform the wire end processing onto, for example, a plurality of single-core electric wires. There is no specific limitation on the type of electric wire as a target of processing performed by the wire end processing apparatus 10. As shown in FIG. 2, before being mounted on the wire end processing apparatus 10, the multi-core cable 1 is subjected to a process of peeling off a sheath from both of two end portions thereof, a process of loosening the plurality of core wires 2 stranded together, a process of covering the drain wiring 3 with a thermally shrinkable tube, a process of peeling off a cover from each of end portions of the core wires 2 to expose end portions 2a, and the like. In this embodiment, the wire end processing apparatus 10 crimps a terminal 5 (see FIG. 3) onto each of the end portions 2a of the plurality of core wires 2. In the example shown in this embodiment, the multi-core cable 1 includes five core wires 2 (four core wirings 4 and one drain wiring 3). The wire end processing apparatus 10 crimps the terminal 5 onto both of the two end portions of each of the core wires 2, that is, crimps the terminal 5 onto each of ten end portions 2a in total. For this purpose, the multi-core cable 1 is folded into a U shape, and the all the end portions 2a of the multi-core cable 1 are directed in the same direction.

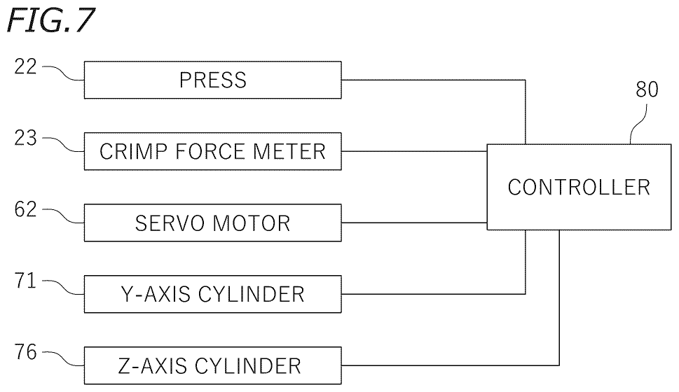

As shown in FIG. 3, the wire end processing apparatus 10 according to this embodiment includes a crimping device 20, an electric wire insertion device 30 inserting the core wires 2 into the crimping devices 20, and a controller 80 (see FIG. 7). In the following description, a direction toward the crimping device 20 from the electric wire insertion device 30 will be defined as the “front” for the wire end processing apparatus 10, and will be represented with letter F. The “left” and the “right” for the wire end processing apparatus 10 are defined as the left and the right for a person or the like directed toward the front. In the drawings, the letters F, Rr, L, R, U and D respectively represent front, rear, left, right, up and down for the wire end processing apparatus 10. These directions are defined for the sake of description, and do not limit the manner of installation of the wire end processing apparatus 10 in any way. In the following description, the left-right direction for the wire end processing apparatus 10 will also be referred to as an “X-axis direction”. Similarly, the front-rear direction for the wire end processing apparatus 10 will also be referred to as a “Y-axis direction”. The up-down direction for the wire end processing apparatus 10 will also be referred to as a “Z-axis direction”. The X-axis direction, the Y-axis direction and the Z-axis direction are perpendicular to each other.

The crimping device 20 crimps the terminal 5 onto each of the ends of the electric wires (in this embodiment, each of the end portions 2a of the core wires 2 of the multi-core cable 1). The crimping device 20 crimps the terminal 5 onto one core wire 2 at a time. In this embodiment, the terminal 5 to be crimped onto each of the end portions 2a of a front end IF (see FIG. 2) of the multi-core cable 1 and the terminal 5 to be crimped onto each of the end portions 2a of a rear end 1Rr (see FIG. 2) of the multi-core cable 1 are of different types from each other. Therefore, the wire end processing apparatus 10 includes two crimping devices 20. The two crimping devices 20 is aligned in the left-right direction. The two crimping devices 20 have substantially the same configurations. Therefore, one of the crimping devices 20 will be described below, and the description of the other crimping device 20 will be omitted. The other crimping device 20 is not shown in the drawings.

As shown in FIG. 3, the crimping device 20 includes an applicator 21, a press 22 (see FIG. 7) pressing the applicator 21, and a crimp force meter (see FIG. 7) 23. The applicator 21 includes a crimper 21a and an anvil 21b, which are dies usable to form the terminal 5 by molding. The crimper 21a and the anvil 21b face each other in the Z-axis direction (up-down direction). When the press 22 is driven in a state where the terminal 5 is supplied to a position between the crimper 21a and the anvil 21b and the end portion 2a of the core wire 2 is inserted into the applicator 21, the crimper 21a and the anvil 21b approach each other and the terminal 5 is crimped onto the end portion 2a of the core wire 2. The crimp force meter 23 measures a pressing pressure of the press 2 at the time of crimping. In the case where the pressing pressure measured by the crimp force meter 23 is within a predetermined range, the wire end processing apparatus 10 determines that the crimping is successful. In the case where the pressing pressure measured by the crimp force meter 23 is out of the predetermined range, the wire end processing apparatus 10 determines that the crimping is unsuccessful.

The electric wire insertion device 30 is provided to the rear of the two crimping devices 20. As shown in FIG. 1, the electric wire insertion device 30 includes a plurality of clamps 40A through 40J each capable of gripping one core wire 2, a shuttle 50 supporting the plurality of clamps 40A through 40J, an X-axis moving device 60 moving the shuttle 50 in the X-axis direction (left-right direction), and a YZ-axis moving unit 70 moving the clamps 40A through 40J in the Y-axis direction (front-rear direction) while moving the shuttle 50 in the up-down direction. The X-axis moving device 60 and the YZ-axis moving unit 70 are included in a moving device that moves the plurality of clamps 40A through 40J to mount the core wires 2 on the crimping device 20. As described below in detail, the X-axis moving device 60 and the YZ-axis moving unit 70 included in the moving device are capable of moving the plurality of clamps 40A through 40J toward the crimping device 20 independently from each other.

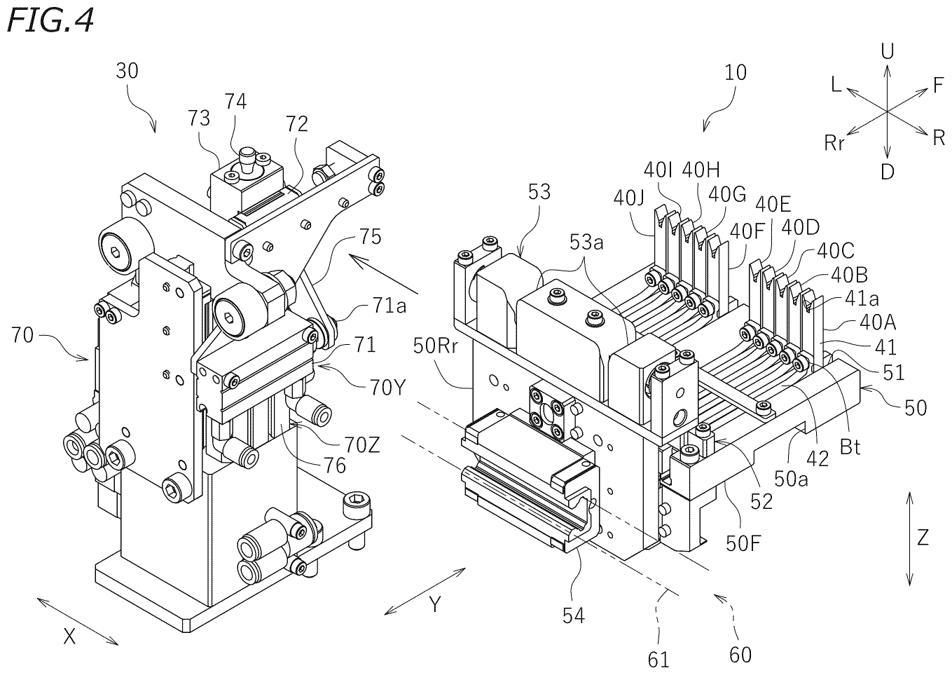

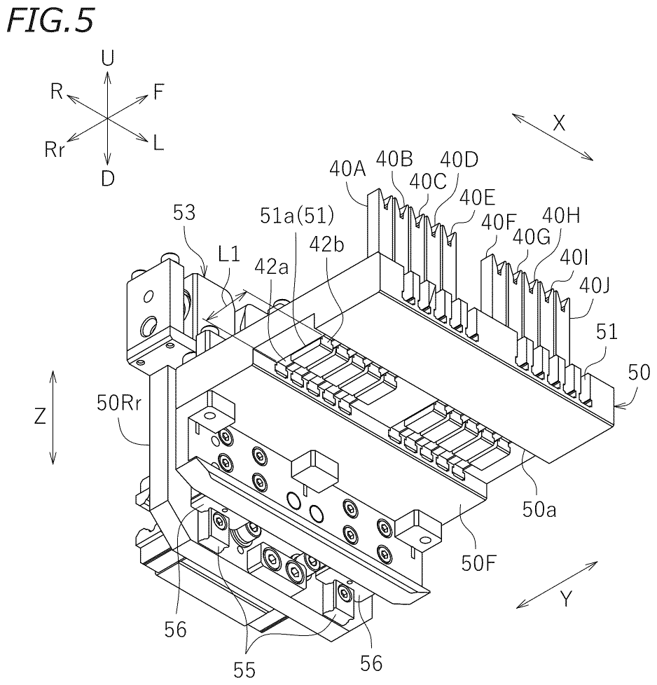

FIG. 4 is a perspective view of the electric wire insertion device 30 in a state where the shuttle 50 and a main portion of the YZ-axis moving unit 70 are away from each other. As described below in detail, the shuttle 50 is moved in the X-axis direction by the X-axis moving device 60, and as a result, approaches, or is separated from, the main portion of the YZ-axis moving unit 70. As shown in FIG. 4, the shuttle 5 includes a planar portion 50F extending in the X-axis direction and the Y-axis direction, and a support portion 50Rr provided to the rear of, and supporting, the planar portion 50F. The support portion 50Rr supports the planar portion 50F such that the planar portion 50F is movable in the Z-axis direction. FIG. 5 is a bottom perspective view of the shuttle 50. As shown in FIG. 5, the support portion 50Rr includes a pair of guide rails 55 extending in the Z-axis direction. The planar portion 50F is provided with a linear movement guide 56, which is slidably engageable with the pair of guide rails 55.

As shown in FIG. 4, the planar portion 50F of the shuttle 50 includes a plurality of guide grooves 51, with which the plurality of clamps 40A through 40J are in movable engagement respectively. In this embodiment, there are ten guide grooves 51. The plurality of guide grooves 51 are aligned in the X-axis direction, and extend in the Y-axis direction. The clamps 40A through 40J are movable in the Y-axis direction along the guide grooves 51. The Y-axis direction is a moving direction of the clamps 40A through 40J, and the X-axis direction is an alignment direction of the clamps 40A through 40J. The shuttle 50 supports the plurality of clamps 40A through 40J such that the plurality of clamps 40A through 40J are aligned in the X-axis direction and are movable in the Y-axis direction perpendicular to the X-axis direction. The shuttle 50 is movable in the direction perpendicular to the Y-axis direction, which is the moving direction of the clamps 40A through 40J (the shuttle 50 is movable in the X-axis direction).

As shown in FIG. 5, the planar portion 50F includes a groove 50a, extending in the X-axis direction, formed in a central area in the Y-axis direction of a bottom surface thereof. The groove 50a runs through the planar portion 50F in the X-axis direction up to both of two side surfaces thereof. As shown in FIG. 5, in the area where the groove 50a is provided, the guide grooves 51 run through the planar portion 50F down to the bottom surface thereof to form a plurality of through-holes 51a. Bottom surfaces of the clamps 40A through 40J are partially exposed from the through-holes 51a respectively.

As shown in FIG. 2, a holding mechanism 52 for the clamps 40A through 40J is provided to the rear of the guide grooves 51. The holding mechanism 52 holds the plurality of clamps 40A through 40J at rear-side end positions thereof in the Y-axis direction. The holding mechanism 52 includes a block 52a and a plurality of ball plungers 52b. The block 52a is provided adjacent to rear ends of the guide grooves 51, and extend in the X-axis direction. The block 52a includes a plurality of insertion holes 52c corresponding to the guide grooves 51 in a one-to-one relationship. The insertion holes 52c are each located to the rear of the corresponding guide groove 51. When the clamps 40A through 40J are located at the rear-side end positions in the Y-axis direction, rear end portions of the clamps 40A through 40J are inserted into the insertion holes 52c. The block 52a has the plurality of ball plungers 52b embedded therein. The plurality of ball plungers 52b correspond to the insertion holes 52c in a one-to-one relationship. The ball plungers 52b are each provided above the corresponding insertion hole 52c, and a ball thereof partially protrudes into the insertion hole 52c. The ball of each ball plunger 52b is pressed downward by a spring. When the rear end portions of the clamps 40A through 40J are inserted into the insertion holes 52c, the balls of the ball plungers 50b are pressed by the clamps 40A through 40J to move upward. The clamps 40A through 40J are pressed downward by the balls of the ball plungers 52b. As a result, the plurality of clamps 40A through 40J are held at the rear-side end positions thereof in the Y-axis direction.

A cable holding portion 53 holding the multi-core cable 1 is provided on the support portion 50Rr of the shuttle 50. As shown in FIG. 4, the cable holding portion 53 includes two holding grooves 53a aligned in the X-axis direction. The two holding grooves 53a extend in the Y-axis direction. As shown in FIG. 2, a part of the front end 1F of the multi-core cable 1 folded into the U shape is inserted through the right holding groove 53a. A part of the rear end 1Rr of the multi-core cable 1 folded into the U shape is inserted through the left holding groove 53a. As a result, both of the two ends 1F and 1Rr of the multi-core coble 1 are located to the front of the cable holding portion 53 (closer to the clamps 40A through 40J). A central folding portion of the multi-core cable 1 is located to the rear of the cable holding portion 53. The multi-core cable 1 is held by the cable holding portion 53, so that the posture of the multi-core cable 1 in the shuttle 50, especially, the posture thereof while the shuttle 50 is moving is stabilized.

A linear movement guide 54 is provided on a rear surface of the support portion 50Rr. As shown in FIG. 1, the linear movement guide 54 is in slidable engagement with a guide rail 61 of the X-axis moving device 60 (the guide rail 61 is represented with the two-dot chain line such that the YZ-axis moving unit 70 are shown in an easy-to-see manner). The guide rail 61 extends in the X-axis direction. The linear movement guide 54 is in slidable engagement with the guide rail 61, and therefore, the shuttle 50 is movable in the X-axis direction along the guide rail 61. The X-axis moving device 60 moves the shuttle 50 in the X-axis direction. The X-axis moving device 60 includes the guide rail 61, a servo motor 62 (see FIG. 7), and a ball screw mechanism (not shown). When the servo motor 62 is driven, the shuttle 50 moves in the X-axis direction along the guide rail 61. While the crimping is performed onto the core wires 2, the position of the shuttle 50 in the X-axis direction varies in accordance with the end portion 2a onto which the terminal crimping is being performed. In addition, the crimping needs to be performed with high positional precision. For these reasons, the servo motor 62, which is capable of controlling the position, is used as an actuator of the X-axis moving device 60. The number of positions at which the shuttle 50 stops is equal to the number of the end portions 2a. The actuator of the X-axis moving device 60 is not limited to the servo motor 62.

Each of the plurality of clamps 40A through 40J is moved in the Y-axis direction while gripping one corresponding core wire 2, and thus causes the end portion 2a of the core wire 2 to approach, or be separated away from, the crimping device 20. Among the plurality of clamps 40A through 40J, five right clamps 40A through 40E respectively grip the end portions 2a of the front end 1F of the multi-core cable 1. Five left clamps 40F through 40J respectively grip the end portions 2a of the rear end 1Rr of the multi-core cable 1. Among the plurality of clams 40A through 40J, the clamps 40A through 40D and 40G through 40J grip the core wirings 4. The clamps 40E and 40F grip the drain wiring 3. The eight clamps gripping the core wirings 4 are of the same type. Thus, in the following description, the rightmost clamp 40A will be described, and the description of the seven other clamps that are the same as the clamp 40A will be omitted. Regarding the clamps 40E and 40F gripping the drain wiring 3, only differences from the claim 40A will be described.

As shown in FIG. 4, the clamp 40A includes a sandwiching portion 41, a slidable portion 42, and a bolt Bt securing the sandwiching portion 41 and the slidable portion 42. The sandwiching portion 41 sandwiches the core wire 2. The sandwiching portion 41 is replaced with another one in accordance with the type of the electric wire. The sandwiching portion 41 is detachable from the slidable portion 42. The sandwiching portion 41 is detached from the slidable portion 42 by the bolt Bt being detached. The clamp 40E and the clamp 40F are different from the clamp 40A on the type of the sandwiching portion 41, and are the same as the clamp 40A on the other points. As shown in FIG. 4, the sandwiching portion 41 extends in the Z-axis direction. A bottom end of the sandwiching portion 41 is secured to a front end of the slidable portion 42 by the bolt Bt. A top end of the sandwiching portion 41 includes a clamp groove 41a sandwiching the core wire 2. The clamp groove 41a is formed to extend downward from a tip of the sandwiching portion 41. The clamp groove 41a has a width in the X-axis direction that is slightly narrower than a diameter of the core wiring 4. Therefore, when the core wiring 4 is pushed into the clamp groove 41a, the core wiring 4 is held by the clamp 40A by an elastic force of the cover of the core wiring 4. In the case of the clamp 40E and the clamp 40F each gripping the drain wiring 3, the width of the clamp groove 41a corresponds to the diameter of the drain wiring 3.

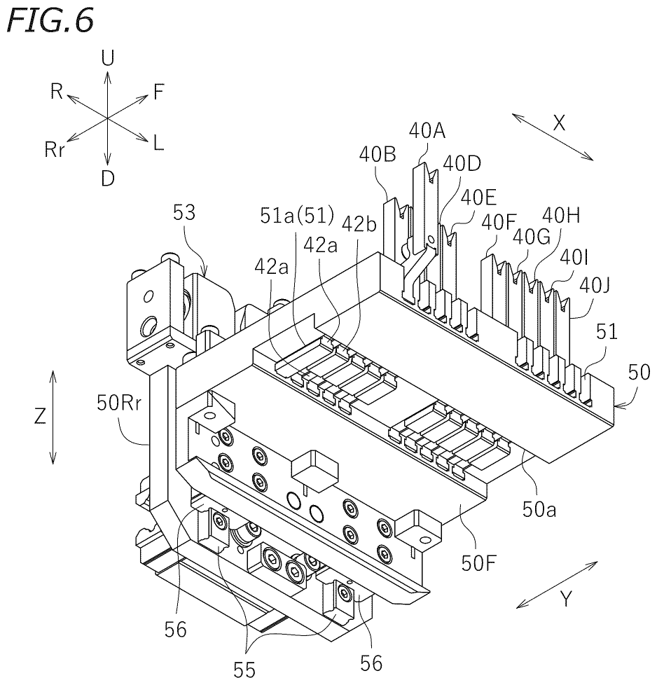

The slidable portion 42 extends in the Y-axis direction and is in engagement with the guide groove 51 of the shuttle 50. The front end of the slidable portion 42 is connected with the sandwiching portion 41. As seen in the X-axis direction, the clamp 40A is generally L-shaped. As shown in FIG. 5, the clamp 40A includes an engagement groove 42a and a clearance groove 42b formed in a bottom surface thereof. The engagement groove 42a is engageable with an engagement pin 74 (see FIG. 4) described below. The engagement groove 42a runs through the clamp 40A in the X-axis direction up to both of two side surfaces thereof, such that the engagement pin 74 may pass through the clamp 40A in the X-axis direction. The clearance groove 42b is provided to the front of the engagement groove 42a in the Y-axis direction (toward the crimping device 20 from the clamp 40A in the Y-axis direction) and is away therefrom by a predetermined distance L1. The distance L1 is equal to a length, in the Y-axis direction, of a movable range of the clamp 40A. FIG. 6 is a bottom perspective view of the shuttle 50 in a state where the rightmost clamp 40A is at a front-side end position thereof. As shown in FIG. 6, when the rightmost clamp 40A is at the front-side end position thereof and the other clamps 40B through 40J are at the rear-side end positions thereof, the position of the engagement groove 42a of the rightmost clamp 40A and the positions of the clearance grooves 42b of the other clamps 40B through 40J match each other in the Y-axis direction. The clearance groove 42b also runs through the clamp 40A in the X-axis direction up to both of the two side surfaces thereof, such that the engagement pin 74 may pass through the clamp 40A in the X-axis direction. Therefore, as shown in FIG. 5 and FIG. 6, in a state where each of the clamps 40A through 40J is at the front-side end position or the rear-side end position thereof, two routes through which the engagement pin 74 may pass in the X-axis direction are formed.

The YZ-axis moving unit 70 includes a Y-axis moving device 70Y moving the plurality of clamps 40A through 40J supported by the shuttle 50 in the Y-axis direction independently from each other, and a Z-axis moving device 70Z moving the planar portion 50F of the shuttle 50 in the Z-axis direction. As shown in FIG. 4, the Y-axis moving device 70Y includes a Y-axis cylinder 71 as an actuator, a guide rail 72, a pin table 73, the engagement pin 74, and a coupling member 75. In this embodiment, the Y-axis cylinder 71 is an air cylinder. The actuator of the Y-axis moving device 70Y may be a two-position actuator, and therefore, an air cylinder is preferably usable as the actuator of the Y-axis moving device 70Y. The actuator of the Y-axis moving device 70Y is not limited to an air cylinder. The Y-axis cylinder 71 is an actuator that moves the engagement pin 74 in the Y-axis direction. The Y-axis cylinder 71 includes a rod 71a expandable in the Y-axis direction. The engagement pin 74 is supported from below by the pin table 73, and the pin table 73 is in movable engagement with the guide rail 72. The guide rail 72 extends in the Y-axis direction. The pin table 73 and the engagement pin 74 are movable in the Y-axis direction along the guide rail 72. The coupling member 75 couples the pin table 73 and the rod 71a of the Y-axis cylinder 71 to each other. Therefore, when the rod 71a extends, the pin table 73 and the engagement pin 74 move forward. When the rod 71a contracts, the pin table 73 and the engagement pin 74 move rearward. The engagement pin 74 may be moved in the Y-axis direction to move any one of the clamps 40A through 40J in the Y-axis direction. This will be described below in detail. The distance between a front-side end position and a rear-side end position of a movable range of the engagement pin 74 is also the distance L1.

The Z-axis moving device 70Z includes a Z-axis cylinder 76. Although not shown, the Z-axis cylinder 76 includes a rod extendable in the Z-axis direction. When the rod of the Z-axis cylinder 76 extends, the Y-axis moving device 70Y and the planar portion 50F of the shuttle 50 move upward along the guide rails 55 of the support portion 50Rr. As a result, the plurality of clamps 40A through 40J also move upward. When the rod contracts, the Y-axis moving device 70Y, the planar portion 50F of the shuttle 50 and the plurality of clamps 40A through 40J move downward.

FIG. 7 is a block diagram of the wire end processing apparatus 10. As shown in FIG. 7, the controller 80 of the wire end processing apparatus 10 is connected with the press 22 and the crimp force meter 23 of the crimping device 20, the servo motor 62 of the X-axis moving device 60, the Y-axis cylinder 71 of the Y-axis moving device 70Y and the Z-axis cylinder 76 of the Z-axis moving device 70Z, and controls movements thereof. The controller 80 controls the X-axis moving device 60, the Y-axis moving device 70Y and the Z-axis moving device 70Z included in the moving device to mount the core wire 2 on the crimping device 20. The controller 80 controls the press 22 of the crimping device 20 to crimp the terminal 5 onto the end portion 2a of the core wire 2. At this point, the controller 80 acquires a pressing pressure measured by the crimp force meter 23 to determine whether the crimping work is successful or unsuccessful.

### [Terminal Crimping Process]

Hereinafter, an example of terminal crimping process performed by the wire end processing apparatus 10 according to this embodiment will be described. FIG. 4 shows a state of the wire end processing apparatus 10 for causing the clamps 40A through 40J to grip the core wires 2. The core wires 2 are gripped by the clamps 40A through 40J in a state where the shuttle 50 is away from the main portion of the YZ-axis moving unit 70. The plurality of core wires 2 of the multi-core cable 1 are attached to the clamps 40A through 40J by another device or a work performed by an operator. A covered portion of the multi-core cable 1 is attached to the cable holding portion 53. As shown in FIG. 3, at this point, the multi-core cable 1 is attached such that the core wires 2 are loosened between the covered portion and the clamps 40A through 40J. As a result, the clamps 40A through 40J are each moved in the Y-axis direction without the corresponding core wire 2 being pulled.

In the next step, the shuttle 50 is moved leftward by the X-axis moving device 60. As a result, the shuttle 50 is moved to a position where the rightmost clamp 40A is located above the engagement pin 74. A purpose of the shuttle 50 being moved to such a position is to perform crimping first onto the core wire 2 gripped by the rightmost clamp 40A. The shuttle 50 may be moved to a position where any other clamp is located above the engagement pin 74. After the shuttle 50 is moved leftward, the Z-axis moving device 70Z is driven to move the Y-axis moving device 70Y, the planar portion 50F of the shuttle 50 and the plurality of clamps 40A through 40J upward. FIG. 1 and FIG. 3 show the wire end processing apparatus 10 at this point. As shown in FIG. 1, the Y-axis moving device 70Y in FIG. 1 is located at a level higher than that in FIG. 4.

As shown in FIG. 3, the rear-side end position, in the Y-axis direction, of the engagement pin 74 is the same as the rear-side end positions, in the Y-axis direction, of the engagement grooves 42a of the clamps 40A through 40J. In addition, the level of a top end of the engagement pin 74 is higher than the level of the bottom surfaces of the clamps 40A through 40J and lower than the level of top surfaces of the engagement grooves 42a. Therefore, when the shuttle 50 is moved to the position shown in FIG. 1, the engagement pin 74 is guided into the engagement groove 42a of the clamp 40A. As a result, the clamp 40A is put into engagement with the engagement pin 74. In a state where any other clamp is located above the engagement pin 74, that clamp is put into engagement with the engagement pin 74. Hereinafter, the position, in the X-axis direction, at which the engagement pin 74 is positioned will be referred to as an “engagement position”. Each of the clamps 40A through 40J is put into engagement with the engagement pin 74 when being at the engagement position.

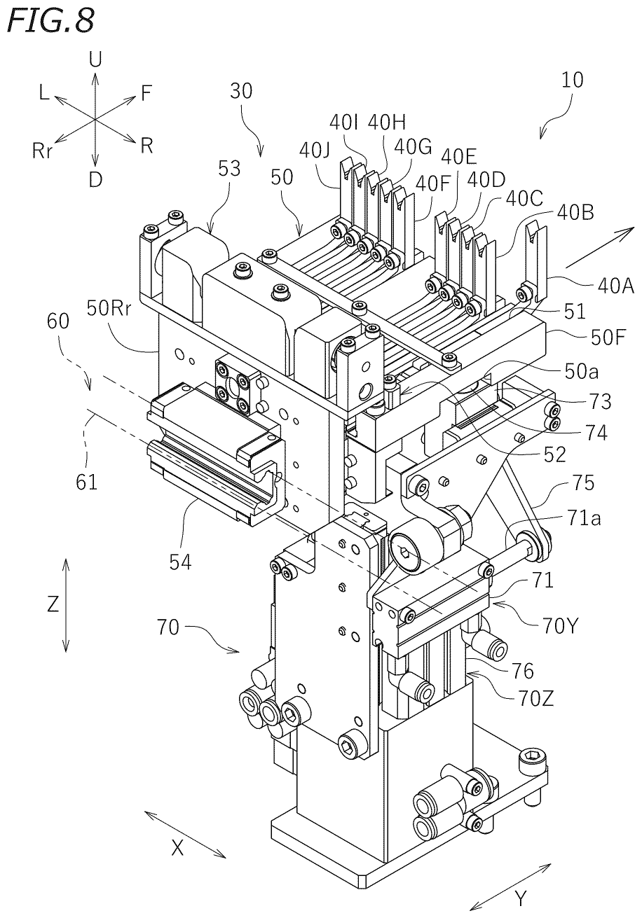

In the next step, the Y-axis moving device 70Y is controlled by the controller 80 to move the engagement pin 74 to the front-side end position thereof. At this point, the engagement pin 74 pushes a front wall of the engagement groove 42a of the clamp 40A. As a result, the clamp 40A moves to the front-side end position thereof. A force of the engagement pin 74 to push the clamp 40A causes the clamp 40A to be away from the holding mechanism 52. FIG. 8 is a perspective view showing the electric wire insertion device 30 in a state where the rightmost clamp 40A is at the front-side end position thereof. As shown in FIG. 8, the engagement pin 74 is moved forward, and as a result, only the rightmost clamp 40A protrudes toward the crimping device 20. In addition, only the core wire 2 gripped by the rightmost clamp 40A approaches the crimping device 20. This is also applicable to the movement of the other clamps 40B through 40J. In order to move each of the clamps 40A through 40J in the Y-axis direction, the controller 80 first controls the X-axis moving device 60 to locate the each of the clamps 40A through 40J at the engagement position (the position, in the X-axis direction, of the engagement pin 74) and drives the Y-axis cylinder 71 in this state.

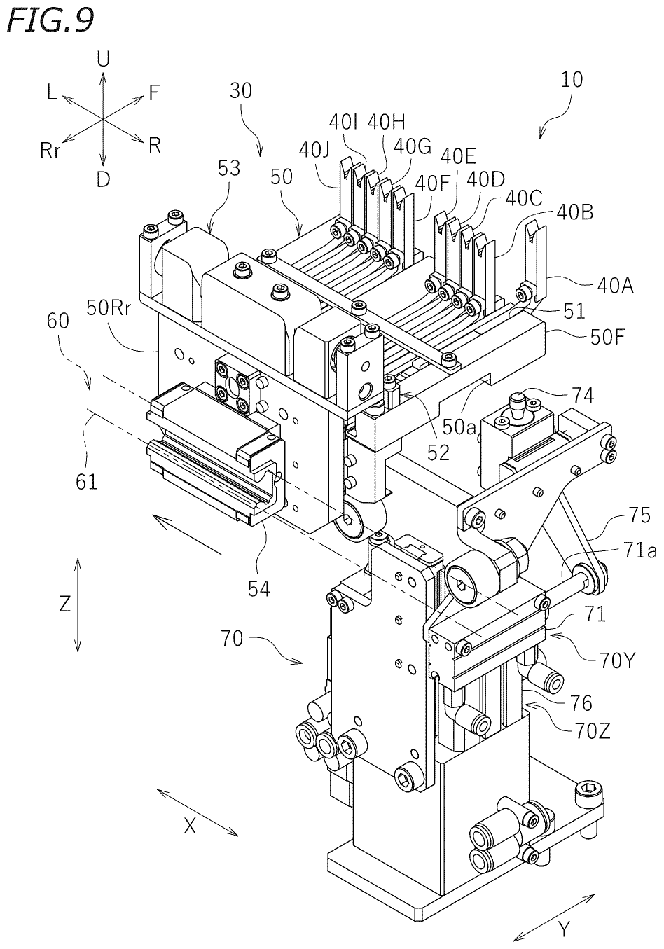

In this embodiment, the controller 80 moves the engagement pin 74 to the front-side end position thereof to move the clamp 40A to the front-side end position thereof, and then moves the clamp 40A to a central position, in the X-axis direction, of the crimper 21a. In this manner, the controller 80 inserts the core wire 2 to a position between the crimper 21a and the anvil 21a. That is, the core wire 2 is inserted between the crimper 21a and the anvil 21b from a position to the side of the applicator 21. This decreases the risk of the end portion 2a of the core wire 2 colliding against the applicator 21. The risk of the electric wire colliding against the applicator 21 is lower in the case where the electric wire is inserted into the applicator 21 from a position to the side of the applicator 21 than in the case where the electric wire is inserted into the applicator 21 from a position facing the applicator 21. Hereinafter, the above-described position of the clamp 40A opposing the crimper 21a and the anvil 21b of the crimping device 20 will be referred to as an “opposing position of the clamp 40A”. The positions of the other clamps 40B through 40J opposing the crimper 21a and the anvil 21b of the crimping device 20 will be referred to as “opposing positions of the clamps 40B through 40J” respectively. FIG. 9 is a perspective view of the electric wire insertion device 30 in a state where the shuttle 50 is moved to the opposing position of the clamp 40A. In a state where each of the clamps 40A through 40J is located at the front-side end position thereof, the position, in the Y-axis direction, of the end portion 2a of the core wire 2 overlaps the position of the crimper 21a and the anvil 21b. The clamps 40A through 40J grip the core wires 2 such that the core wires 2 each protrude by a length with which the position of the end portion 2a of the core wire 2 overlaps the position of the crimper 21a and the anvil 21b as described above.

After inserting the core wire 2 between the crimper 21a and the anvil 21b, the controller 80 causes the crimper 21a and the anvil 21b to approach each other and to crimp the terminal 5 onto the core wire 2. Specifically, the press 22 is driven. At this point, the controller 80 acquires a pressing pressure measured by the crimp force meter 23 to determine whether the crimping work is successful or unsuccessful.

At the same time as the press 22 being driven, the controller 80 controls the Z-axis moving device 70Z to move the Y-axis moving device 70Y, the planar portion 50F of the shuttle 50 and the plurality of clamps 40A through 40J downward. As a result, the core wire 2 is accommodated in the terminal 5 immediately before the crimper 21a and the anvil 21 get close to each other. Therefore, the terminal 5 and the core wire 2 are crimped onto each other with certainty. After this, the Y-axis moving device 70Y, the planar portion 50F of the shuttle 50 and the plurality of clamps 40A through 40J are returned to the level before the terminal crimping.

After this, the controller 80 controls the X-axis moving device 60 to return the clamp 40A to the engagement position in the X-axis direction. As a result, the rightmost clamp 40A is put into engagement with the engagement pin 74 again. After moving the clamp 40A to the engagement position to put the clamp 40A into engagement with the engagement pin 74, the controller 80 moves the engagement pin 74 to the rear-side end position thereof. As a result, the crimping work of the terminal 5 onto the core wire 2 gripped by the rightmost clamp 40A is finished.

In the next step, another terminal 5 is crimped onto the core wire 2 gripped by another clamp, for example, the clamp 40B. The crimping work of the terminal 5 onto the core wire 5 gripped by the clamp 40B is performed as follows. The shuttle 50 is moved by the X-axis moving device 60 to a position where the clamp 40B is above the engagement pin 74, that is, to the engagement position of the clamp 40B. The shuttle 50 is allowed to move in this manner in the X-axis direction because the engagement groove 42a of each of the clamps 40A through 40J runs up to both of the left side surface and the right side surface thereof. While the shuttle 50 is moved in the X-axis direction, the engagement pin 74 passes through a continuous path (see FIG. 5) formed of the engagement grooves 42a of the clamps 40A through 40J in the X-axis direction. Then, the clamp 40B moves forward, the shuttle 50 moves to the opposing position of the clamp 40B, the crimping is performed, the shuttle 50 returns, and the clamp 40B retracts to the rear-side end position thereof, as in the case of the clamp 40A. While the shuttle 50 is returned to the original position thereof in the X-axis direction, the engagement pin 74 passes through the clearance groove 42b of the clamp 40A and goes into the engagement groove 42a of the clamp 40B (see FIG. 6). The shuttle 50 is allowed to move in this manner in the X-axis direction because the clearance grooves 42b of the clamps 40A through 40J are away from the engagement grooves 42a by the distance L1 and run through the clamps 40A through 40J up to both of the left side surface and the right side surface thereof.

After this, the core wires 2 gripped by the other clamps 40C through 40J are subjected to the same step. As can be see, the controller 80 of the wire end processing apparatus 10 controls the Y-axis moving device 70Y and the X-axis moving device 60 to move the plurality of clamps 40A through 40J sequentially to the front-side end positions thereof in the Y-axis direction and also to the opposing positions thereof opposing the crimping device 20. As a result, the core wires 2 gripped by the clamps 40A through 40J thus moved are sequentially mounted on the crimping device 20.

### Functions and Effects of the Embodiment

Hereinafter, the functions and the effects of the wire end processing apparatus 10 according to this embodiment will be described, as compared with a conventional wire end processing apparatus optionally.

The wire end processing apparatus 10 according to this embodiment includes the crimping device 20 crimping the terminal 5 onto the end portion 2a of the core wire 2, the plurality of clamps 40A through 40J each capable of gripping one core wire 2, and a moving device capable of moving the plurality of clamps 40A through 40J toward the crimping device 20 independently from each other. The moving device mounts the core wire 2 gripped by the moved clamp on the crimping device 20. In this embodiment, the moving device includes the X-axis moving device 60, the Y-axis moving device 70Y and the Z-axis moving device 70Z. According to the wire end processing apparatus 10 having such a configuration, the plurality of core wires 2 are gripped at the same time by the plurality of clamps 40A through 40J, each capable of gripping one core wire 2. As a result, a situation is prevented where a core wire 2 that is not gripped contacts the wire end processing apparatus 10, and the time for switching the core wire 2 to be gripped becomes unnecessary. In addition, in this embodiment, the Y-axis moving device 70Y is capable of moving the plurality of clamps 40A through 40J toward the crimping device 20 independently from each other. Therefore, only the core wire 2 gripped by the moved clamp is mounted on the crimping device 20. Thus, the plurality of core wire 2 are subjected to the crimping sequentially one by one. As a result, the crimping is performed onto the plurality of core wires 2 one by one, and also the time required for the crimping is shortened.

As described above, according to the conventional wire end processing apparatus, the electric wire to be gripped needs to be switched in order to allow the terminal crimping to be performed onto the electric wires one by one and also in order to prevent the electric wire that is not a target of the crimping from interfering with the wire end processing apparatus. Such switching extends the time required for the crimping process. The wire end processing apparatus 10 according to this embodiment solves all of the problem of quality management of the terminal crimping, the problem of a crimping error caused by the electric wire that is not a target of the crimping contacting the wire end processing apparatus, and the problem of the time required for the process.

More specifically, the wire end processing apparatus 10 according to this embodiment includes the shuttle 50 supporting the plurality of clamps 40A through 40J such that the plurality of clamps 40A through 40J are aligned in the X-axis direction and are movable in the Y-axis direction perpendicular to the X-axis direction. The moving device includes the Y-axis moving device 70Y moving the plurality of clamps 40A through 40J supported by the shuttle 50 in the Y-axis direction independently from each other, and the X-axis moving device 60 moving the shuttle 50 in the X-axis direction. The controller 80 sequentially moves the plurality of clamps 40A through 40J to the front-side end positions thereof in the Y-axis direction and also to the opposing positions thereof opposing the crimping device 20. According to such a configuration, the moving device moving the plurality of clamps 40A through 40J toward the crimping device 20 independently from each other is realized with a simple configuration by a combination of the X-axis moving device 60 causing the clamp, gripping the core wire 2 as a target of the crimping, to oppose the crimping device 20 and the Y-axis moving device 70Y causing the clamp, gripping the core wire 2 as the target of the crimping, to approach the crimping device 20.

In this embodiment, the Y-axis moving device 70Y includes the engagement pin 74 and the Y-axis cylinder 71 moving the engagement pin 74 in the Y-axis direction. Each of the clamps 40A through 40J is put into engagement with the engagement pin 74 when being at the engagement position above the engagement pin 74. According to this configuration, the plurality of clamps 40A through 40J are moved in the Y-axis direction independently from each other with one actuator (in this embodiment, the Y-axis cylinder 71) with no need to provide an actuator for each of the clamps.

In this embodiment, the front-side end position and the rear-side end position of the movable range of the engagement pin 74 are away from each other by the distance L1 in the Y-axis direction. The clamps 40A through 40J each include the engagement groove 42a, which runs therethrough in the X-axis direction up to both of the two side surfaces thereof such that the engagement pin 74 may pass therethrough in the X-axis direction, and which is engageable with the engagement pin 74. The clamps 40A through 40J each include the clearance groove 42b, which is to the front of the engagement groove 42a and is away from the engagement groove 42a by the distance L1 in the Y-axis direction, and which runs therethrough in the X-axis direction up to both of the two side surfaces thereof such that the engagement pin 74 may pass therethrough in the X-axis direction. According to this configuration, the shuttle 50 is moved in the X-axis direction with no interference with the engagement pin 74 even where all the clamps are retracted or even where one of the clamps is moved forward toward the crimping device 20. The movement of inserting the core wire 2 into the applicator 21 from a position to the side of the applicator 21 is made possible by the clearance groove 42b provided in each of the clamps 40A through 40J.

The wire end processing apparatus 10 according to this embodiment includes the holding mechanism 52 holding the plurality of clamps 40A through 40J at the rear-side end positions thereof in the Y-axis direction. According to this configuration, a situation is prevented where the clamp gripping the core wire 2 that is not a target of the crimping moves from the rear-side end position thereof while the shuttle 50 is moved in the X-axis direction by the X-axis moving device 60. In this embodiment, the holding mechanism 52 holds the clamps 40A through 40J by the ball plunger 52b. There is no specific limitation on the system of holding the clamps 40A through 40J. The holding mechanism 52 may hold the clamps 40A through 40J by, for example, a magnet.

In this embodiment, the clamps 40A through 40J each include the sandwiching portion 41, which is replaceable in accordance with the type of the electric wire and which sandwiches electric wire. According to this configuration, the crimping is performed for various types of electric wires. The member that is replaced in accordance with the type of the electric wire does not need to be the sandwiching portion 41 as a part of each of the clamps 40A through 40J. The member that is replaced in accordance with the type of the electric wire may be, for example, the clamps 40A through 40J. Alternatively, the member that is replaced in accordance with the type of the electric wire may be, for example, the shuttle 50 having the clamps 40A through 40J attached thereto.

### Other Embodiments

A preferred embodiment of the present invention is described above. The above-described embodiment is merely an example, and the present invention may be carried out in various other embodiments. For example, in the above-described embodiment, the clamps 40A through 40J are moved by two devices (the X-axis moving device 60 and the Y-axis moving device 70Y) moving the clamps 40A through 40J in directions perpendicular to each other, and are mounted on the crimping device 20. The moving device moving the clamps toward the crimping device independently from each other is not limited to such a device. For example, the plurality of clamps may be located radially with respect to one crimping device and approach toward the crimping device independently from each other. The plurality of clamps may be moved by different actuators from each other.

In this embodiment, the clamps 40A through 40J are translated in the X-axis direction perpendicular to the Y-axis direction, which is an approach direction in which the clamps 40A through 40J approach the crimping device 20. Alternatively, the clamps 40A through 40J may be circled so as to cross the approach direction toward the crimping device 20. For example, the shuttle 50 may move a selected clamp to the opposing position that opposes the crimping device 20 by a circling motion instead of the translating motion. The direction crossing the approach direction toward the crimping device 20 includes the moving direction of such a circling motion.

In this embodiment, the core wire 2 is inserted into the applicator 21 from a position to the side of the applicator 21. Alternatively, the core wire 2 may be inserted into the applicator 21 from a position facing the applicator 21. In this case, the engagement pin 74 is provided at a position opposing the applicator 21, and the clamps 40A through 40J do not need to include the clearance grooves.

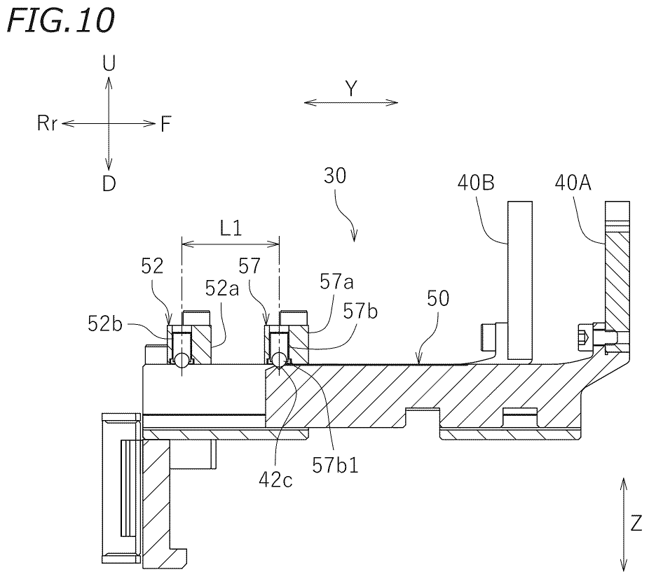

In the above-described embodiment, the holding mechanism 52 holds the clamps 40A through 40J at the rear-side end positions thereof. Alternatively, the holding mechanism may hold the clamps 40A through 40J at the rear-side end positions and the front-side end positions thereof. FIG. 10 is a vertical cross-sectional view of the clamps 40A through 40J, the holding mechanism 52 and a holding mechanism 57 according to such a modification. As shown in FIG. 10, the holding mechanisms 52 and 57 according to this modification include the rear-side holding mechanism 52 and the front-side holding mechanism 57. The rear-side holding mechanism 52 holds the clamps 40A through 40J at the rear-side end positions thereof, and may be the same as the holding mechanism 52 in the above-described embodiment. The front-side holding mechanism 57 is provided to the front of the rear-side holding mechanism 52 by the distance L1.

As shown in FIG. 10, the front-side holding mechanism 57 holds the clamp 40A at a position to the front of the rear-side end position thereof by the distance L1, that is, at the front-side end position thereof. The crimping onto the core wire 2 held by the clamp 40A is performed in a state where the clamp 40A is at the front-side end position thereof. The front-side holding mechanism 57 includes a block 57a and a ball plunger 57b. As shown in FIG. 10, the clamp 40A includes a recessed portion 42c, into which a ball 57b1 of the ball plunger 57b is fitted at the front-side end position thereof. The recessed portion 42c is, for example, a groove that is triangular as seen in the X-axis direction and extends in the X-axis direction. There is no specific limitation on the shape of the recessed portion 42c. The clamps 40B through 40J also each include substantially the same recessed portion 42c. The ball 57b1 of the ball plunger 57b is partially fitted into the recessed portion 42c to hold the corresponding clamp among the clamps 40A through 40J. The position, in the Y-axis direction, of the clamp 40A at the time of the terminal crimping is correctly determined by the front-side holding mechanism 57 and the recessed portion 42c of the clamp 40A, despite a backlash between the engagement pin 74 and the engagement groove 42a. While the terminal is crimped and while the shuttle 50 is moved, the clamp 40A is held at this position with certainty. By contrast, the other clamps 40B through 40J waiting without the terminal crimping are held at the rear-side end positions thereof by the rear-side holding mechanism 52 and the recessed portions 42c. This is applicable to the case where the crimping is performed onto the core wire 2 gripped by each of the other clamps 40B through 40J.

The above-described embodiments do not limit the present invention unless otherwise specified. For example, the configuration of the electric wire gripping portion of each of the clamps is not limited to the clamp groove 41a or the like in the above-described embodiment. The electric wire gripping portion of each of the clamps may include, for example, a claw including a movable portion and may grip the electric wire with such a claw.

### REFERENCE SIGNS LIST

2 Core wire (electric wire)
5 Terminal
10 Wire end processing apparatus
20 Crimping device
21a Crimper
21b Anvil
30 Electric wire insertion device
40A-40J Clamp (gripping member)
41 Sandwiching portion
42a Engagement groove
42b Clearance groove
50 Shuttle (base member)
52 Holding mechanism (first holding mechanism)
57 Holding mechanism (second holding mechanism)
60 X-axis moving device (second moving device)
70Y Y-axis moving device (first moving device)
71 Y-axis cylinder (actuator)
74 Engagement pin (engagement member)
80 Controller

1. A wire end processing apparatus, comprising:
a crimping device crimping a terminal onto an end portion of an electric wire;
a plurality of gripping members each capable of gripping one electric wire; and
a moving device capable of moving the plurality of gripping members toward the crimping device independently from each other, the moving device mounting the electric wire gripped by the moved gripping member on the crimping device.

2. The wire end processing apparatus according to claim 1, further comprising:
a base member supporting the plurality of gripping members such that the plurality of gripping members are aligned in a predetermined alignment direction and are each movable in a moving direction crossing the alignment direction, and
a controller controlling the moving device to mount the electric wire on the crimping device,
wherein:
the moving device includes:
a first moving device moving the plurality of gripping members supported by the base member in the moving direction independently from each other, and
a second moving device moving the base member in the alignment direction,
the crimping device is provided on one side in the moving direction with respect to the base member, and
the controller controls the first moving device and the second moving device to sequentially move the plurality of gripping members to one-side end positions thereof in the moving direction and also to opposing positions thereof opposing the crimping device.

3. The wire end processing apparatus according to claim 2, wherein:
the first moving device includes:
an engagement member provided at a predetermined engagement position in the alignment direction, and
an actuator moving the engagement member in the moving direction,
the gripping members are each put into engagement with the engagement member when being located at the engagement position, and
when moving each of the gripping members in the moving direction, the controller drives the actuator after controlling the second moving device to locate the each of the gripping members at the engagement position.

4. The wire end processing apparatus according to claim 3, wherein:
a one-side end position and an other-side end position of a movable range of the engagement member are away from each other by a first distance in the moving direction, and
the gripping members each include:
an engagement groove running through the gripping member in the alignment direction up to both of two side surfaces thereof such that the engagement member passes therethrough in the alignment direction, the engagement groove being engageable with the engagement member, and
a clearance groove provided to be away from the engagement groove by the first distance in the moving direction toward the one-side end of the gripping member, the clearance groove running through the gripping member in the alignment direction up to both of the two side surfaces thereof such that the engagement member passes therethrough in the alignment direction.

5. The wire end processing apparatus according to claim 4, wherein:
the crimping device includes a crimper and an anvil facing each other in a crimping direction perpendicular to the alignment direction and the moving direction, and
the controller:
moves the engagement member to the one-side end position thereof and then moves each of the gripping members to the opposing position thereof to insert the electric wire between the crimper and the anvil,
after inserting the electric wire between the crimper and the anvil, causes the crimper and the anvil to approach each other to crimp the terminal onto the electric wire,
after crimping the terminal, moves the each of the gripping members to the engagement position in the alignment direction, and
after moving the each of the gripping members to the engagement position, moves the engagement member to the other-side end position thereof.

6. The wire end processing apparatus according to any one of claims 2 through 5, further comprising a first holding mechanism holding the plurality of gripping members at other-side end positions thereof in the moving direction respectively.

7. The wire end processing apparatus according to any one of claims 2 through 6, further comprising a second holding mechanism holding the plurality of gripping members at the one-side end positions thereof in the moving direction respectively.

8. The wire end processing apparatus according to any one of claims 1 through 7, wherein the gripping members each include a sandwiching portion replaceable in accordance with the type of the electric wire, the sandwiching portion sandwiching the electric wire.
